(19) United States
(12) Patent Application Publication
(10) Pub. No.: US 2008/0283489 A1
(43) Pub. Date: Nov. 20, 2008

(54) Method of Manufacturing a Structure

(75) Inventors: Dirk Burdinski, Eindhoven (NL); Ruben Bernardus Alfred Sharpe, Enschede (NL); Martin Hillebrand Blees, Eindhoven (NL); Jurriaan Huskens, Enschede (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/091,602

(22) PCT Filed: Oct. 24, 2006
(86) PCT No.: PCT/IB2006/053906

§ 371 Date: Apr. 25, 2008

(30) Foreign Application Priority Data
Oct. 28, 2005 (EP) 05110109.5

(51) Int. Cl. H01B 13/00

(52) U.S. Cl. 216/13

(57) ABSTRACT

A gold layer (20) is patterned with a gold oxide mask (30), which mask is patterned with an acid, preferably with microcontactprinting. The gold oxide mask (30) is stable in alkalic etch solutions for the gold layer (20). The gold oxide mask (30) may be maintained to create a reexposable gold pad (20).

The invention relates to a method of manufacturing a structure on a gold layer by the provision of a mask thereon.

The invention also relates to a method of manufacturing a microelectronic device comprising the manufacture of such a structure.

Such a method is for instance known from US-A 2004/0102050. The known method is a specific example of microcontact printing. That patterning method involves the patterning of a surface by transferring a material from a stamp to a substrate layer according to the pattern that is provided on a stamping surface of the stamp. The transferred material forms then a self-assembled monolayer, also known as SAM, on the substrate. A most suitable substrate layer is gold, and a preferred material to form a SAM is an alkanethiol, particularly n-octadecanethiol. Suitably, the SAM is used as an etch mask for the subsequent etching of the substrate layer, although other use is not excluded. However, this method seems to be too slow. The known method proposes the transfer of another material than an alkanethiol in microcontact printing, and immersion in a bath with an alkanethiol to fill the rest of the surface of the gold layer. Thereafter, the other material, for instance pentaerythritol-tetrakis(3-mercaptopriopionate) is removed. This has the advantage that the other material does not need to form a perfect SAM that is resistant to an etchant for the underlying substrate layer. As a consequence, the speed of transfer may be substantially increased.

It is however disadvantageous that the resulting substrate layer is covered with the SAM, as one would like to have the substrate layer exposed, either for applying further layers in the manufacture of a microelectronic device, or to contact the substrate layer, such as gold. Evidently, the SAM may be removed subsequently, but therefore one needs an oxidative plasma treatment. Such a plasma treatment effectively limits the application of microcontact printing, as it is basically a method to be carried out in a cleanroom and may be harmful to other materials on the substrate surface.

It is therefore an object of the invention to provide an alternative embodiment of patterning and of microcontact printing particularly, in which the substrate layer may be exposed easily after that a process step has been carried out on the gold layer that is exposed through the mask.

This object is achieved in that the method of manufacturing a structure comprises the steps of providing a patterned surface of a gold layer by oxidizing and patterning the surface to create an oxide mask, and carrying out a process step on the exposed gold layer through the mask.

According to the invention, a gold oxide mask is formed on the gold layer. It has been found that such as gold oxide mask can be prepared adequately in a process in which a gold oxide layer is provided by oxidizing the gold in an oxidizing atmosphere such as a plasma apparatus, and the surface of the gold layer is patterned with any form of soft lithography. With nanoimprint lithography, the patterning occurs before the oxidation, while in microcontact printing the oxidation occurs before the patterning. Alternatively, although not preferred, the gold layer may be patterned and oxidized at once with the use of an oxidizing agent in a patterned manner. The agent is for instance a plasma, an electrochemical reagent, a focused ion beam, a focused laser beam in the presence of oxygen, or a scanning probe lithographic agent.

The use of a gold oxide mask is advantageous, as it may be removed with a mild reductant or with an acid, while it is stable and even useful as an etch mask in alkaline solutions. This allows the exposure of the gold layer at any desired moment after the application of the gold oxide mask. It additionally allows a partial or selective removal of the gold oxide mask. This removal moreover can be carried out with an acid that does not need to be very strong or with a suitable reducing agent that also does not need to be very strong. It thus allows processing outside a cleanroom and it allows local removal of the gold oxide mask from a substrate that comprises further and even mutually different layers.

Gold oxide is per se known. Appl. Phys. A, 71 (2000), 331-335 discusses the preparation of gold oxide films on substrates of SrTiO₃, sapphire and Si using magnetron sputtering. It also reports the reduction of the gold oxide film to gold by scanned focused laser and scanned focused ion-beam irradiation. However, this is actually a completely different process. Additionally the film thickness with 100 nm is different from what is got when oxidizing a gold layer in a plasma. Tomomi Sakata et al. (NTT Microsystem Integration Laboratories), ‘Pre- and Post-Treatment for electrodeposition of organic dielectrics on gold electrodes’, as published on the internet, state that gold oxide may be formed during oxygen plasma formation and that it may be dissolved by hydrochloric acid, but this does not disclose anything about the use hereof for providing a patterned surface to the gold layer.

The resulting gold oxide mask may be exploited in several ways that will be discussed hereafter. As will be clear, the process steps to be carried out on the exposed gold layer are either deposition or etching. Unexpectedly, it was found that the gold oxide layer has a good stability against base solutions, whereas its stability in acid or neutral solutions is poor. For the deposition step, it is a big advantage that the gold oxide layer is an oxide, acting as an inorganic, polar material.

First of all, the oxide mask may be removed after completion of the process step on the gold layer. As stated above, the advantage is that this can be carried out easily. If the process step is an etching step, then the removal of the oxide mask is aimed at the exposure of the gold layer so as to carry out further process steps or to allow contact. Contact may be made, for instance, with probes, electrodes and other conductors, but also by selectively adsorbing materials, such as biomolecules. If the process step is a deposition step, for instance of an electrically conductive material, the gold layer may be removed after removal of the oxide mask. A specific example hereof is for instance an electroplating process. In another example, the gold oxide mask may be removed only partially. In a further example, a solder or bump material is selectively deposited. The portion of the gold layer that has been temporarily protected by the gold oxide mask, may thereafter be used for other purposes, such as testing. In an even further example, the portion of the gold layer that is protected with the gold oxide, may be kept free of further layers, such as electroplated layers, for instance to apply a solder material or the like thereon afterwards.

Secondly, the oxide mask may be applied on a gold layer that has been patterned before. The use of the oxide mask in combination with pre-patterning is very fruitful. For instance, local areas may be defined for adhesion or for further deposition, even up to the manufacture of vertical interconnects. Alternatively, when using the gold oxide mask as an etching mask, it allows to achieve further micro- or nanopatterning of already pre-patterned surfaces. This appears advantageous to increase the resolution of gold patterns that have been created with a process such as electroplating. Eventually, the gold may be used again as an etch mask for underlying metal layers. It is herein observed that soft lithography, particularly as embodied in wave printing, such as known from WO-A 2003/99463, is able to provide patterns on such non-planar surfaces.

Thirdly, another mask may be applied on the exposed gold layer in a desired pattern after the provision of the gold oxide mask. Particularly suitable herein is the use of a self-assembled monolayer, such as an alkanethiol, as the second mask. Not only may this mask be deposited with microcontact printing, but it also turns out that the etch resistivities of the alkanethiol and the gold oxide are orthogonal: Whereas the gold oxide is stable in alkaline solutions, the alkanethiol is stable in both alkaline and acid solutions.

This combination of masks may be exploited to increase the resolution of the ultimate pattern. This increased resolution, enabled with stamps of relatively large feature sizes, occurs when the both masks overlap: then a high resolution gold pattern is left after removal of both the exposed portion of the gold layer and the portion under the gold oxide mask. Use of wave printing appears favorable here again, as it allows to align the stamp used for the patterning of the gold oxide layer and for the provision of the self-assembled monolayer according to the same alignment marks.

Another exploitation hereof occurs in combination with the application of further material on the exposed portion of the gold layer. While the exposed portion is made thicker, the portion covered with the self-assembled monolayer remains at the same thickness, while the portion covered with the gold oxide layer may be removed.

Still another application makes use thereof that a self-assembled monolayer such as an alkanethiol has an apolar surface, due to the alkane-chains of the molecules. The gold oxide layer is however polar. This difference in surface properties may be exploited to deposited a further material without the need for an additional etch mask. Eventually, if the portion with the gold oxide mask is not covered with any further layer, the gold layer thereunder may be accessed at a later stage in the process. In addition to testing, this appears very useful for trimming passive components and optionally for programming: the thus locally exposed gold layer may be removed, therewith cutting an interconnect line.

It will be clear that the manufacture of the structure may be part of the manufacture of a microelectronic device such as a semiconductor device, a passive network, a filter, a biosensor or array type of device for measuring biomolecules, another type of sensor and the like.

These and other aspects of the method of the invention will be further explained with reference to the Figures, that are purely diagrammatical and not drawn to scale, and wherein like reference numerals in different Figures refer to like constituents, wherein:

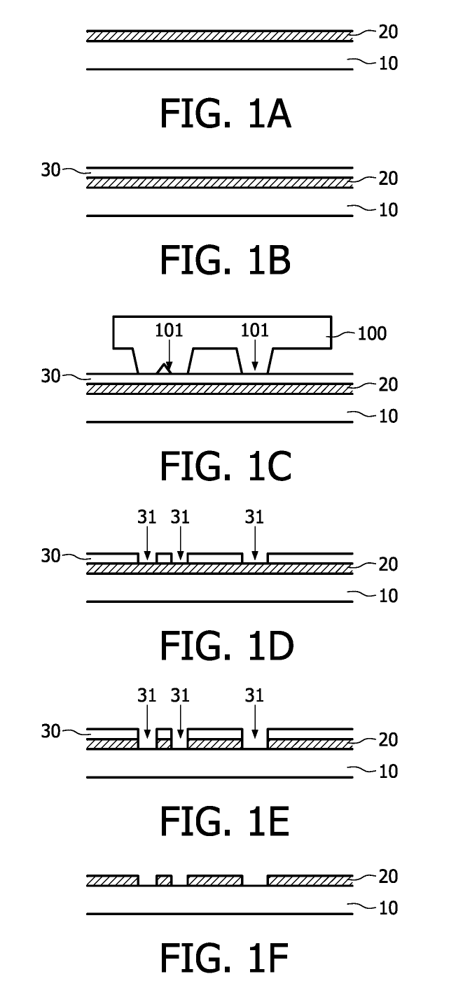

FIGS. 1A-F show in a cross-sectional view six stages of a first embodiment of the method;

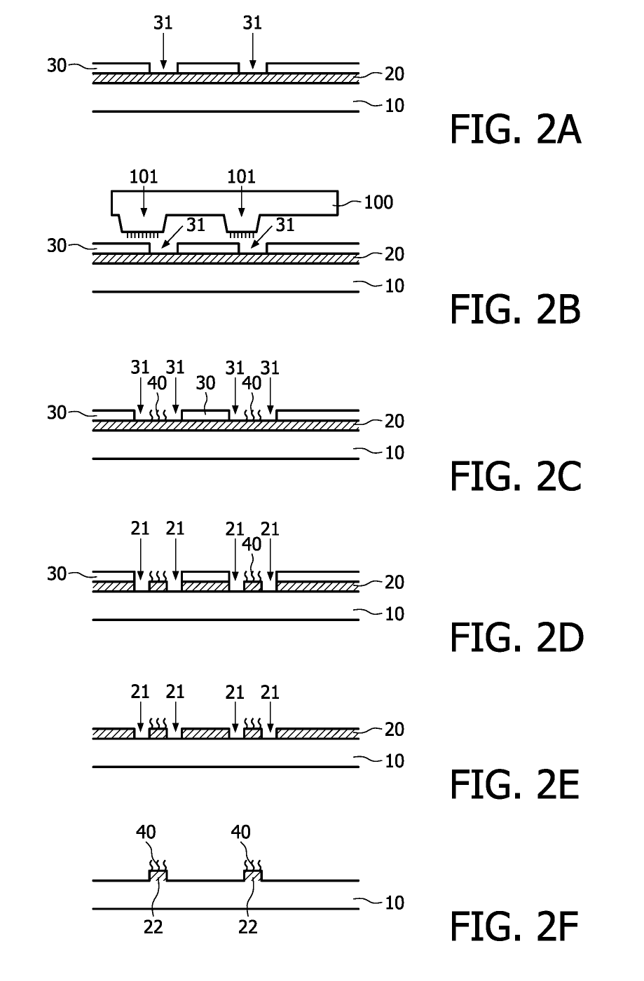

FIGS. 2A-F show in a cross-sectional view six stages of a second embodiment of the method;

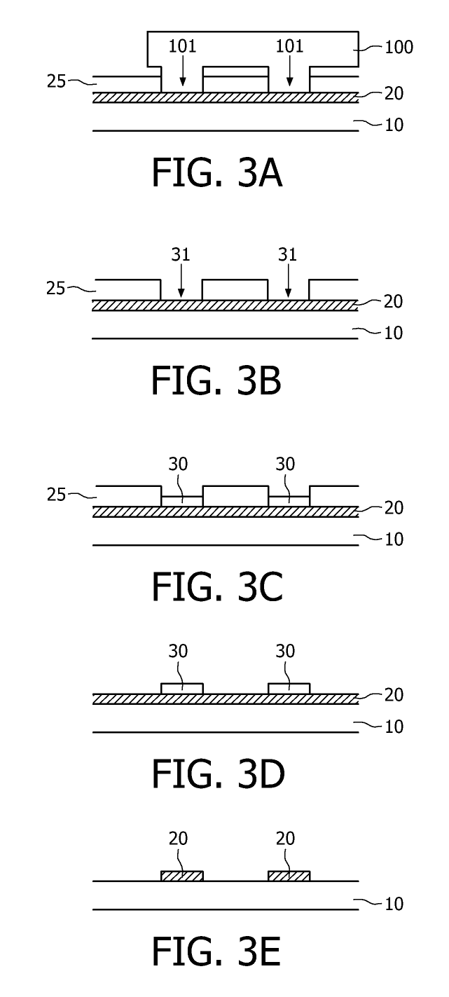

FIGS. 3A-E show in a cross-sectional view five stages of a third embodiment of the method;

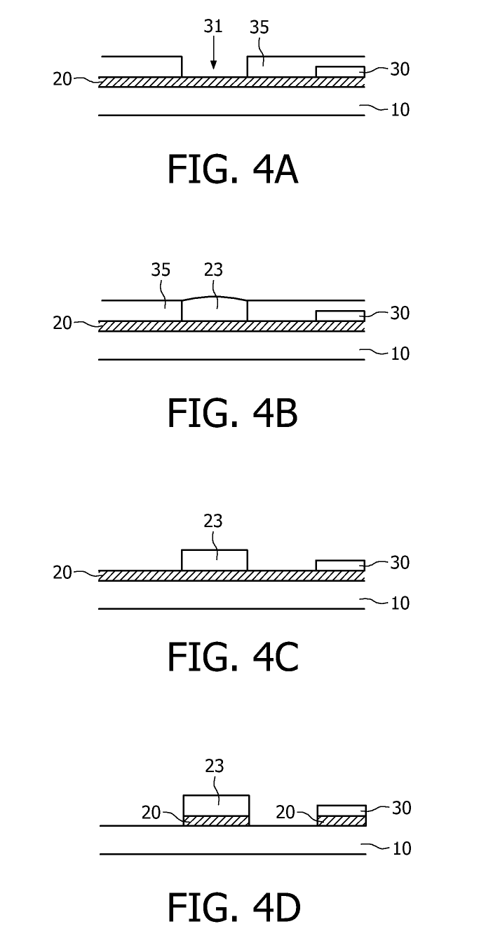

FIGS. 4A-D show in a cross-sectional view four stages of a fourth embodiment of the method;

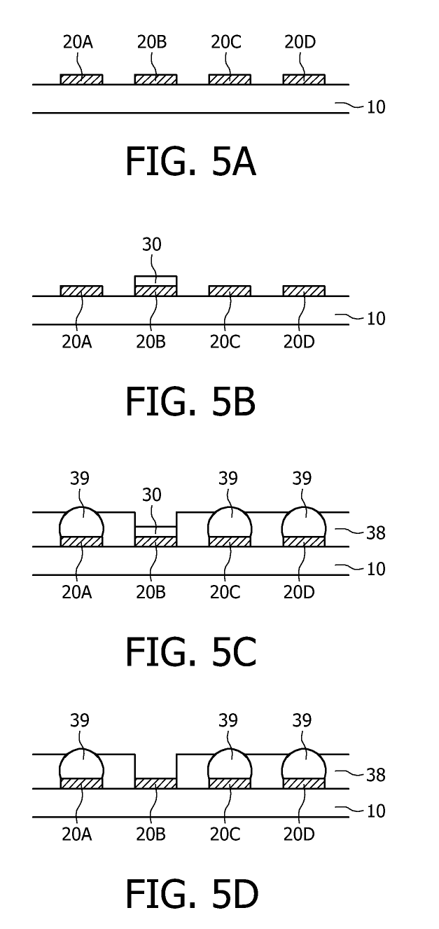

FIGS. 5A-D show in a cross-sectional view four stages of a fifth embodiment of the method;

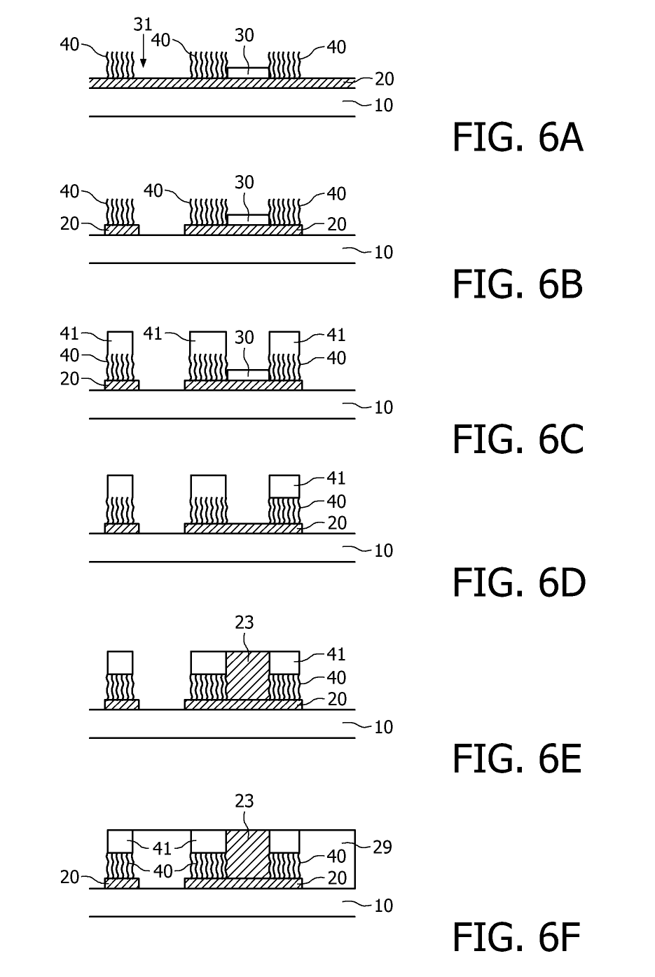

FIGS. 6A-F show in a cross-sectional view six stages of a sixth embodiment of the method;

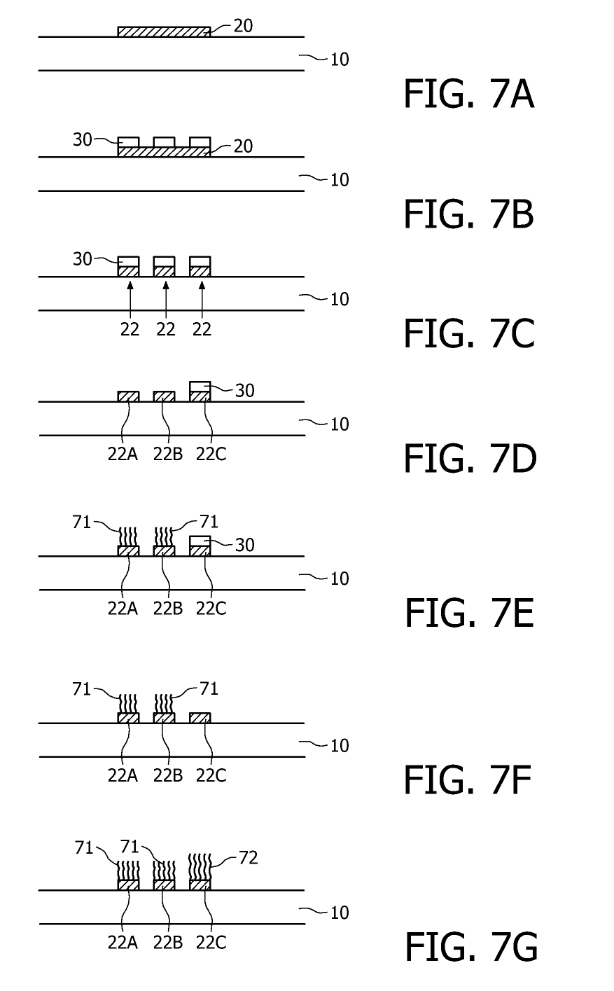

FIGS. 7A-G show in a cross-sectional view seven stages of an seventh embodiment of the method;

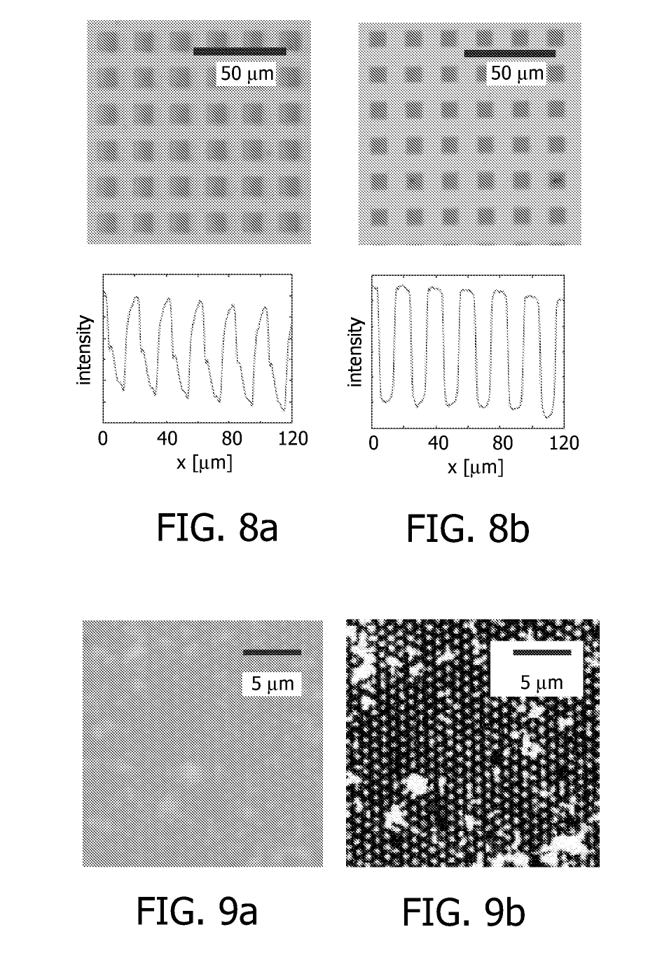

FIGS. 8A and B show optical micrographs of the obtained structure in a gold layer for two different etchants, and corresponding intensity profiles;

FIG. 9 shows optical micrographs of a hexagonal array of gold pillar structures, that have been created with the method of the invention;

FIG. 1 shows in a cross-sectional view six stages in a first embodiment of the method of the invention. Use is made of microcontactprinting for the patterning of the gold oxide layer in this embodiment. Thus, patterning occurs after oxidation. More details are given in Examples 1-7

FIG. 1A shows a substrate 10 with thereon a gold layer 20. The substrate is a substrate of silicon. It has been thermally oxidized and provided with a Ti adhesion layer. Hereafter a gold oxide layer 30 is provided by oxidation of the gold layer 20 in a plasma treatment (FIG. 1B). Then, the gold oxide layer 30 is patterned using a stamp 100 (FIG. 1C). The stamp 100, suitable for microcontactprinting, is provided with a stamp surface 101 in a desired pattern. As known to the skilled person, such a stamp is suitably made from PDMS, and any ink is provided into the stamp 100 before stamping. The ink comprises a solvent with an active component. In this example, the active component is an etchant. FIG. 8a shows a micrograph and an intensity profile for experiments carried out with triphenylphosphine as the active component and ethanol as the solvent. FIG. 8b shows a micrograph and an intensity profile for experiments carried out with dithiothreitol as the active component and toluene as the solvent. The result of the patterning of the gold oxide layer 30 with apertures 31 is shown in FIG. 1D. The result of the etching of the gold layer 20 is shown in FIG. 1E. The result after removal of the gold oxide layer, with a mild acid, is shown in FIG. 1F. An advantage of this patterning method is that once the oxidation is carried out in a plasma treatment, the contactprinting step may be carried out later on, and without special equipment.

Several stamp designs are known in microcontactprinting. Suitable is a stamp with recesses that become narrower with an increasing distance to the stamp surface, such as known from WO-A 2001/59523. Advantageous is a stamp with a chemically patterned surface, such as described in the non-prepublished application WO-IB2005/052111 (PHNL050195). One of the options to create such stamp is the patterning of the PDMS stamp to an oxygen plasma through a mask. Exposed areas become hydrophilic due to the formation of surface oxo-groups, whereas the unmodified areas remain hydrophobic. This process is reversible, but may be made irreversible by coupling the hydrophilic areas chemically, with the help of certain surface layers. In a modification thereof, the reversibility is exploited to create a reversible pattern on the stamp surface. The recovery to the original state takes some hours but may be accelerated, for instance with a treatment of a reducing plasma. Alternatively, the provision of a reversible state on the surface of the stamp may be achieved physically, e.g. with an electric field induced switching, with thermal switching or with photo-switching. The photoswitching can be suitably achieved with a surface-tethered spiropyran, which can be grafted to (oxidized) PDMS using an amino-terminated tether. The thermal switching can be suitably achieved by the provision of a surface layer of a material that gets a different configuration above a critical temperature and therewith changes its hydrophilicity. The changed configuration is also kept when cooling to room temperature. One example is a thin film of poly(N-isopropylacrylamide) (PNIPAM), for which the critical temperature lies between 30 and 40° C. The electrical switching may be achieved with a monolayer comprising a charged end group that influences its configuration under an electric field from straight to bent. One example is a deprotonated mercaptohexadecanoic acid

FIG. 2 shows in a cross-sectional view six stages of a second embodiment of the method. In FIG. 2A the first stage is shown, which is similar to that of FIG. 1D: a substrate 10 with a gold layer 20 and a gold oxide mask 30, in between of which openings 31 are present.

Hereafter, another mask 40 is provided on the gold oxide layer 30, as shown in FIG. 2B. This is carried out by microcontactprinting with a thiol, such as octadecanethiol. Relevant is here that the used stamp surface 101 of the stamp 100 partly overlaps with the gold oxide layer 30. It has been found that a thiol may reduce the gold oxide mask to form a sulphate. This sulphate is not suitable as an etch mask, although it may be suitable for other masking purposes. The result is thus that the gold oxide is removed in the areas, where the stamp surface 101 contacts the gold oxide 30. The thiol is provided in areas, where the stamp surface 101 contacts the openings 31 in the gold oxide 30 and the gold layer 20 is exposed. The gold oxide mask 30 remains in areas where the stamp surface is recessed.

FIG. 2C shows the resulting etch mask comprising gold oxide portions 30 and thiol portions 40. It will be apparent that the thiol portions 40 have a higher resolution than the original stamp surface 101 of the stamp 100. Simultaneously, also the openings 31 in which the gold layer 20 is exposed have a higher resolution. Now, based on the choice of the etchant, one may either obtain a pattern in which narrow channels 21 are etched into the gold layer 20 (FIG. 2D), or in which narrow structures 22 in the gold layer 20 are left (FIG. 2F). The gold oxide mask 30 and the thiol mask 40 may be subsequently removed with a mild acid and a plasma treatment respectively.

FIG. 3 shows in cross-sectional view four stages in a third embodiment of the method. Herein, use is made of nanoimprintlithography instead of microcontactprinting. This results therein that the desired pattern is provided on the substrate before the oxidation of the gold layer.

FIG. 3A shows a first stage, in which a stamp 100 is applied on the substrate 10 comprising a gold layer 20 and an imprint layer 25. The constitution of imprint layers 25 is known per se in the field. The result is shown in FIG. 3B and comprises a pattern in the imprint layer 25 with apertures 31. Hereafter, a plasma treatment is carried out, therewith providing an oxide layer 30 in the apertures 31. The imprint layer 25 is then removed (FIG. 3D), after which the gold layer 20 is etched while using the gold oxide layer 30 as a mask (FIG. 3E).

FIG. 4 shows in cross-sectional view four stages in a fourth embodiment of the method, in which the mask is used in a deposition process. The example shown is an electroplating process. The gold layer 20 functions herein as the plating base. After the completion of the plating process, the gold layer is partially removed, but some areas therein remain as patterns. As the provided layers in a plating process are generally thick, up to the order of microns, the plating area is herein defined by a conventional photoresist mask. In processes with merely small layer thicknesses, the deposition area could also be defined with a monolayer structure.

FIG. 4A shows the substrate 10 with the gold layer 20 in a first stage. A patterned gold oxide layer 30 is shown. In addition thereto, a photoresist 35 is present with an opening 31 that exposes the gold layer 20. Thereafter the opening 31 is filled with an electrically conductive material such as copper in a plating process (FIG. 4B). Alternatively, use could be made of electroless processes such as known to the skilled person. This results in a conductive pattern 23. Hereafter, the photoresist 35 is removed (FIG. 4C) with a base or with an organic solvent, so as to leave the gold oxide layer 30 in tact. Finally, the gold layer 20 is patterned using the conductive pattern 23 and the gold oxide layer 30 as a combined etch mask (FIG. 4D). The gold oxide layer 30 may now be removed, but could also be maintained, either as protection or in order to open it in a later stage of the process. The result is a structure in which the conductive pattern 23 has a larger thickness than the gold layer 20. Usually, the conductive pattern 23 also comprises another material than gold. The complete structure may now be covered with an optionally planarizing insulator, so that the conductive pattern 23 is exposed and the gold layer is a hidden conductor. Alternatively, use can be made of the conductive pattern 23 for the definition of inductors, for which a reasonable quality factor is required. The gold layer 20 is simultaneously planar and therefore suitable as a bottom electrode for capacitors.

FIG. 5 shows in cross-sectional view four stages in a fifth embodiment of the method. Herein, the gold oxide 30 is used as a mask in assembly.

FIG. 5A shows a substrate 10 with a gold layer 20 that has been patterned in a plurality of pads 20A-D. The substrate 10 is suitably electrically insulating, and may for instance be a molding material such as an epoxy. The gold layer 20 is conventionally used as adhesion layer on top of copper wiring in a leadframe or on a carrier such as a laminate. Examples of leadframe packages wherein copper pads are exposed include HVQFN packages and sacrificial layer packages such as known from WO-A 2003/85728.

FIG. 5B shows the result after the provision of the gold oxide mask 30 on a pad 20B. The use of microcontactprinting of the like appears suitable, as this is an easy manner of providing a pattern in an environment that is not a cleanroom and therefore does not like the use of photolithography

FIG. 5C shows the result after a solder resist 38 and solder bumps 39 are provided. This is carried out with conventional technology. The solder resist 38 is usually screenprinted and the solder bumps comprise a material such as a tin-silver-copper alloy (SAC solder), or a preferably eutectic lead-tin alloy. The solder resist 38 might even be left out. The solder bumps may be provided individually or in any kind of wafer-level process. As will be seen, the oxidized pad is not provided with a solder bump, preferably in a self-aligned process, e.g. due to lack of adhesion between the gold oxide 30 and the solder bump 39.

FIG. 5D shows the result after removal of the oxide mask. Therewith, an exposed gold pad 20 is created. This may be used for testing purposes and for programming purposes. With the trends towards system-in-package and stacked die packages, testing in different stages of the process becomes more and more an issue in order to maintain yield. Simultaneously, the cost price is reduced tremendously, when use is made of wafer-level processes. The creation of test pads that are not covered with solder and are protected with an oxide 30 that is easily removed, appears to contribute to a cost-effective solution.

FIG. 6 shows six stages in again another embodiment of the method of the invention. Herein, use is made of a thiol mask 40 in addition to the gold oxide mask 30. Additionally, use is made of the feature that the thiol mask is apolar, whereas the gold oxide mask is polar, in order to provide a selective deposition step.

FIG. 6A shows the substrate 10 with the gold layer 20 and the gold oxide mask 30 and the thiol mask 40. Suitably, first the gold oxide layer 30 is provided and only then the thiol mask 40. Then an etching step is carried out to remove portions of the gold layer 20 (FIG. 6B). Thereafter, a selective deposition step is carried out so as to provide the thiol mask 40 with a top layer 41. It is not excluded that the top layer 41 also covers the exposed areas of the substrate 10 (FIG. 6C). Then, the gold oxide layer 30 is removed to expose a further area of the gold layer 20 (FIG. 4D). This allows the provision of a further layer 23, such as an electrically conductive layer, on the gold layer 20 (FIG. 4E). Other layers could be applied alternatively to the gold layer 20, for instance reagents, biomolecules or the like. Finally, the structure may be planarized with an insulating layer 29 (FIG. 6F).

FIG. 7 shows seven stages of a seventh embodiment of the method of the invention. Herein, the method of the invention is applied to enhance the resolution of a prepatterned gold layer 20 (FIG. 7A). The gold oxide mask 30 is provided in a manner as mentioned above, preferably with microcontactprinting after oxidation in a plasma treatment (FIG. 7B). Subsequently, the gold layer 20 is patterned into gold pads 22 with a higher resolution. One application example is for instance in printed circuit boards or the like. Herein, the method may be used for enhancement of the resolution of the pads. Such a higher resolution may be needed locally to allow placement of a fine-pitch ball grid array package or another package with fine pitch contact pads or leads. Another example for the local increase of resolution is the creation of an array of pads, for instance for the adhesion of biomolecules in finer dots. The gold pads 22 may even be used as an etch mask to pattern an underlying conductive layer.

FIGS. 7D-G show four further stages, which could also be applied separately, e.g. without the combination of a prepatterned gold layer 20. Herein, the gold oxide 30 is removed selectively, suitably by another contactprinting step. This allows to open some pads 22A, 22B, while others 22C are not exposed (FIG. 7D). Biomolecules 71 are subsequently adhered to the pads 22A, 22B. Thereafter, the further pad 22C is opened, and biomolecules 72 of another sample are adhered. This allows an in-situ comparison of the two kind of biomolecules 71, 72. Labeling and testing biomolecules is known per se, and may for instance be carried out optically and also with magnetoresistive elements.

### EXAMPLE 1

Etch resistance of gold oxide. A silicon waver substrate was modified with a thermal silicon oxide layer (about 250 nm tick), an evaporated titanium adhesion layer (5 nm thick) and an evaporated gold layer (20 nm thick) on top. The substrate was exposed to an oxygen plasma in an oxygen plasma reactor (0.30 mbar O₂, 300 W) for ten minutes. Characterization and processing followed within 30 min. Prior to oxidation, the gold substrates were sequentially rinsed with ultrapure water (resistivity>18 MΩ.cm) and ethanol.

Non-oxidized and oxidized substrates were exposed to different etching solutions to determine the stability of the oxide layer against the etching solutions. Whereas 20 nm of non-treated gold was completely stripped within 10 min in an alkaline etching bath containing potassium hydroxide (1.0 M), potassium thio sulfate (0.1 M), potassium ferricyanide (0.01 M), and potassium ferrocyanide (0.001 M), uniformly oxidized gold only started to show signs of deterioration after more than an hour. An alternative, acidic etching bath contained thiourea (0.1 M), Fe₂(SO₄)₃ (0.01 M), and sulfuric acid (0.01 M). Using this thiourea-based bath, both non-treated and oxidized gold substrates were completely stripped within 2 min.

### EXAMPLE 2

A silicon waver substrate was modified with a thermal silicon oxide layer, an evaporated titanium adhesion layer (5 nm thick) and an evaporated gold layer (20 nm thick) on top and oxidized in an oxygen plasma as described in Example 1. Stamps for microcontact printing were made from poly(dimethylsiloxane) (PDMS), which was obtained from Dow Corning. It was mixed in a 1:10 curing agent/prepolymer ratio and cured overnight at 60° C. A PDMS stamp bearing a surface relief pattern was loaded with a 0.1 molar solution of dithiotreitol in ethanol, dried in a stream of nitrogen, and brought into contact with the oxidized gold substrate for 30 seconds. After removal of the stamp, the gold substrate was etched using an aqueous alkaline etching bath containing potassium hydroxide (1.0 M), potassium thiosulfate (0.1 M), potassium ferricyanide (0.01 M), and potassium ferrocyanide (0.001 M), for 10 minutes. Gold was selectively removed from the areas that were contacted by the protruding features of the stamp to obtain a respective pattern in the substrate.

### EXAMPLE 3

A gold-covered silicon wafer was prepared and oxidized in an oxygen plasma as described in Example 1. A PDMS stamp was loaded with a 0.1 molar solution of triphenylphosphine in ethanol, dried and brought into contact with the substrate as described before. Etching of the surface modified substrate was performed with a solution containing potassium hydroxide (1.0 M), potassium cyanide (0.01 M)), potassium ferricyanide (0.01 M), and potassium ferrocyanide (0.001 M). Gold was selectively removed from the areas that were contacted by the protruding features of the stamp to obtain a respective pattern in the substrate.

### EXAMPLE 4

A gold-covered silicon wafer was prepared and oxidized in an oxygen plasma as described in Example 1. A PDMS stamp was loaded with a 0.1 molar solution of triphenylphosphine (TPP) in ethanol, dried and brought into contact with the substrate as described before. Etching of the surface modified substrate was performed with a solution of potassium hydroxide (1.0 M), potassium thiosulfate (0.1 M), potassium ferricyanide (0.01 M), and potassium ferrocyanide (0.001 M), for 10 minutes. Gold was selectively removed from the areas that were contacted by the protruding features of the stamp to obtain a respective pattern in the substrate (FIG. 8a).

### EXAMPLE 5

A gold-covered silicon wafer was prepared and oxidized in an oxygen plasma as described in Example 4. A PDMS stamp was loaded with a 10 mM solution of dithiothreitol (DTT) in toluene, dried for at least an hour in a stream of nitrogen and brought into contact with the substrate as described before. It was subsequently etched as described in Example 4. Gold was selectively removed from the areas that were contacted by the protruding features of the stamp to obtain a respective pattern in the substrate. The edge definition after etching was further improved, when compared to the result obtained in Example 4, probably due to the smaller contribution of solvent assisted spreading (FIG. 8b).

### EXAMPLE 6

A gold-covered silicon wafer was prepared and oxidized in an oxygen plasma as described in Example 1. A chemically patterned flat PDMS stamp, bearing a 1H,1H,2H,2H-perfluorodecyltrichlorosilane (PFDTS) barrier layer, was prepared as described in Sharpe et al. J. Am. Chem. Soc. 127, 10344-10349 (2005). It was loaded with a 0.1 molar solution of triphenylphosphine in ethanol, dried and brought into contact with the substrate as described before. Etching of the surface modified substrate was performed with a solution potassium hydroxide (1.0 M), potassium thiosulfate (0.1 M), potassium ferricyanide (0.01 M), and potassium ferrocyanide (0.001 M), for 10 minutes. Gold was selectively removed from the areas that were contacted by the protruding features of the stamp to obtain a respective high resolution pattern with sub-micron features in the substrate (FIG. 9).

### EXAMPLE 7

A gold-covered silicon wafer was prepared and oxidized in an oxygen plasma as described in Example 1. A PDMS stamp was loaded with a solution of ascorbic acid in ethanol and used as described before in order to contact print a pattern onto the substrate surface. An etching solution as described in Example 1 was used for development of the pattern. A patterned gold layer was obtained in accordance with the pattern of the used PDMS stamp, in that gold was selectively removed via etching from the areas that were contacted by the protruding features of the stamp. The obtained edge resolution of the pattern was inferior when compared to the results obtained in Examples 1-6.

1. A method of manufacturing a structure, comprising:
providing a patterned surface of a gold layer by oxidizing and patterning the surface to create an oxide mask, and
carrying out a process on the exposed gold layer through the mask.

2. A method as claimed in claim 1, wherein the oxide mask is removed after carrying out the process on the exposed gold layer.

3. A method as claimed in claim 1, wherein the gold layer is etched through the mask with a base.

4. A method as claimed in claim 1, wherein the process includes applying a material to the exposed gold layer.

5. A method as claimed in claim 4, wherein the material is applied by a plating technique.

6. A method as claimed in claim 4, wherein the material selectively adheres to the exposed gold layer.

7. A method as claimed in claim 1, wherein a portion of the gold layer is covered with a self-assembled monolayer after the creation of the mask.

8. A method as claimed in claim 1, wherein the gold layer has been patterned prior to oxidation.

9. A method as claimed in claim 4, further comprising:
covering a portion of the gold layer with a self-assembled monolayer after the creation of the oxide mask,
removing the oxide mask after the application of said material without removal of the self-assembled monolayer, and
etching the gold that is exposed by the removal of the oxide mask.

10. A method as claimed in claim 7, wherein the applied self-assembled monolayer is provided with an apolar surface facing away from the gold layer, and a material is applied that selectively binds to the self-assembled monolayer, leaving the oxide mask exposed, after which the oxide mask and the gold layer is re-exposed to carry out the process.

11. A method as claimed in claim 1, wherein after creation of the oxide mask a material is applied that selectively binds to the oxide mask, and a material is applied that binds to the exposed gold layer.

12. A method as claimed in claim 1, wherein the patterning of the surface is carried out after oxidation of the gold by local reduction by printing the reducing agent.

13. A method as claimed in claim 12, wherein the reducing agent is provided by contact printing.

14. A method as claimed in claim 1, wherein the patterning of the surface is carried out before oxidation by providing a mask, and the oxidation is carried out through the mask.

15. A method as claimed in claim 14, wherein the patterning of the surface is carried out by nanoimprint lithography.

16. A method as claimed in claim 1, wherein the etching of the gold is carried out with a base having a pH of 8 or more.

17. (canceled)

18. A microelectronic device comprising a layer of gold with reexposable pads that are covered with a gold oxide layer and patterns that are covered by a further layer.
